(19) United States
(12) Patent Application Publication
(10) Pub. No.: US 2007/0023095 A1
(43) Pub. Date: Feb. 1, 2007

(54) Vacuum chamber inlet device

(75) Inventors: Chih-Pen Lin, Tu-Cheng (TW); Yong-Ming Li, Shenzhen (CN); Yi-Lin Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/448,568

(22) Filed: Jun. 7, 2006

(30) Foreign Application Priority Data
Jul. 29, 2005 (CN) 200510036285.5

(51) Int. Cl. F16K 11/22

(52) U.S. Cl. 137/883

(57) ABSTRACT

A vacuum chamber inlet device includes a gas providing element (10), a plurality of flow control element (20), and a plurality of gas input elements (30). The gas providing element has an inlet (11) and a plurality of outlets (12). The flow control elements are connected to the outlets of the gas input element. Each of the gas input elements has a first end (31) and a second end (32). The first end is connected to the flow control elements, and the second end is disposed in the vacuum chamber. A gas vent (33) is formed on the second end.

### TECHNICAL FIELD

The present invention generally relates to inlet devices and, more particularly, to a vacuum chamber inlet device.

### BACKGROUND

Vacuum deposition technology has been widely used in surface treatment. A typical vacuum deposition apparatus generally includes a vacuum chamber and an inlet device. The vacuum chamber provides a vacuum space for vacuum deposition, and the inlet device provides a predetermined amount of gas for producing plasma in the vacuum chamber.

A typical example of a contemporary inlet device is shown in FIG. 2. The inlet device includes a gas input pipe 60. One end of the gas input pipe 60 is disposed in a vacuum chamber 50, and a gas vent 61 is formed at this end of the gas input pipe 60. Another end of the gas input pipe 60 is connected to a gas supply (not shown). During a vacuum deposition process, the amount of gas being introduced into the vacuum chamber can be controlled by means of adjusting the gas vent 61.

If gas distribution in the vacuum chamber does not meet a predetermined requirement or is uneven during a vacuum deposition process, the vacuum chamber 50 needs to be opened to adjust the size or position of the gas vent 61, thus destroying the vacuum in the vacuum chamber 50. Therefore, the inlet device has a lower efficiency when adjusting the gas distribution in the vacuum chamber 50.

Therefore, a vacuum chamber inlet device which can overcome the above-described problems is desired.

### SUMMARY

In one embodiment thereof, a vacuum chamber inlet device includes a gas providing element, a plurality of flow control elements, and a plurality of gas input elements. The gas providing element has an inlet and a plurality of outlets. The flow control elements are connected to the outlets of the gas input element. Each of the gas input elements has a first end and a second end. The first end is connected to the flow control elements, and the second end is disposed in the vacuum chamber. A gas vent is formed on the second end.

Other advantages and novel features will become more apparent from the following detailed description when taken in conjunction with the accompanying drawings.

### BRIEF DESCRIPTION OF THE DRAWINGS

Many aspects of the vacuum chamber inlet device can be better understood with reference to the following drawings. The components in the drawings are not necessarily drawn to scale, the emphasis instead being placed upon clearly illustrating the principles of the present vacuum chamber inlet device. Moreover, in the drawings, like reference numerals designate corresponding parts throughout the several views.

FIG. 1 is a schematic view of a vacuum chamber inlet device in accordance with a preferred embodiment; and

FIG. 2 is a schematic view of an inlet device from the related art.

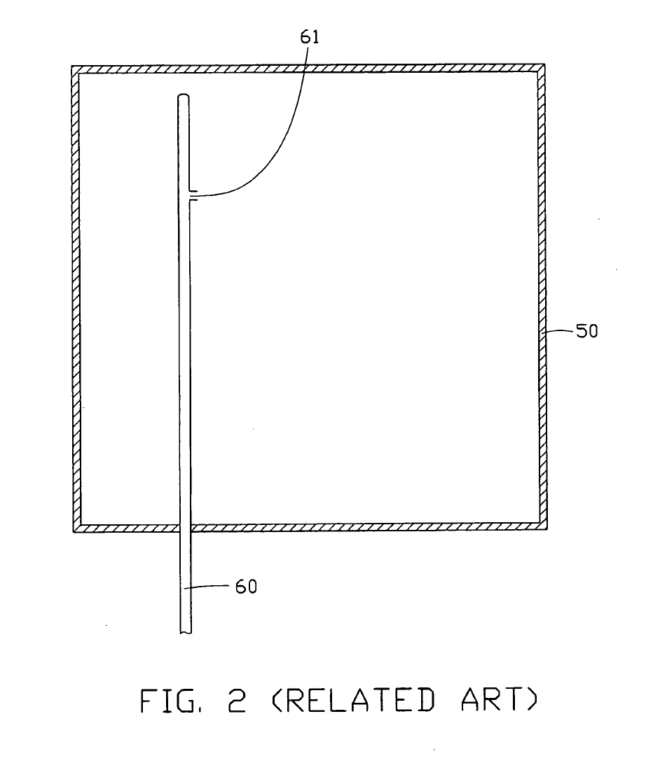

### DETAILED DESCRIPTION OF THE EMBODIMENT

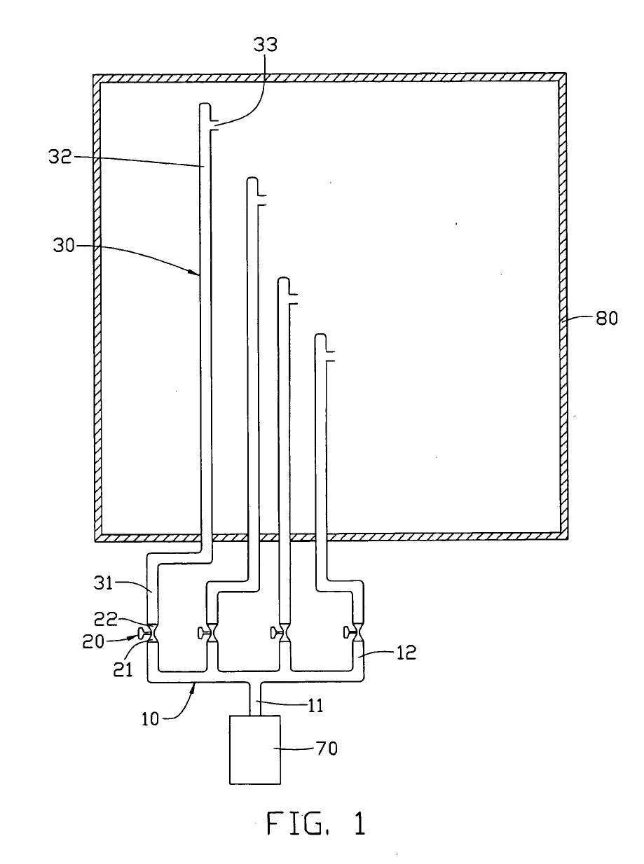

Referring to FIG. 1, in a preferred embodiment, a vacuum chamber inlet device configured for a vacuum chamber 80 includes a gas providing element 10, a predetermined number of flow control elements 20, and a predetermined number of gas input elements 30. In this embodiment, the number of the flow control elements 20 is four. The number of gas input elements 30 is also four.

The gas providing element 10 is pipe shaped, and is disposed outside the vacuum chamber 80. In this embodiment, the gas providing element 10 is a stainless steel pipe. The gas providing element 10 includes an inlet 11 and a plurality of outlets 12. In this embodiment, the number of outlets 12 is four.

The flow control elements 20 may be control valves. The flow control elements 20 are disposed outside the vacuum chamber 80, and each of the flow control elements 20 has an input port 21 and an output port 22. The input ports 21 are connected to the outlets 12 of the gas providing element 10.

Each of the gas input elements 30 has a first end 31 and a second end 32. The first end 31 is connected to the output ports 22 of the flow control element 20. The first end 31 is disposed outside of the vacuum chamber 80, and the second end is disposed inside the vacuum chamber 80. A gas vent 33 is formed on the second end 32 of the gas input element 30. In this embodiment, the gas input elements 30 are pipes, and have different heights in the vacuum chamber 80. Thus the gas vents 33 are located in different portions of the vacuum chamber 80. Understandably, the gas input elements 30 can also have the same length so long as the gas vents 33 are located in different portions of the vacuum chamber 80.

The gas providing element 10 together with a gas supply 70 is used for providing gas to the vacuum chamber 80. The flow control elements 20 are used to control the gas flow. Because the gas vents 33 are located in different portions of the vacuum chamber 80, the vacuum chamber inlet device can use the flow control elements 20 to adjust the gas distribution in different portions of the vacuum chamber.

In use, firstly, the vacuum chamber 80 is evacuated to a predetermined pressure. Secondly, the flow control elements 20 are used to introduce gas into the vacuum chamber 80. Thirdly, the flow control elements 20 are adjusted to control the gas distribution in the vacuum chamber 80 during a vacuum deposition process. Finally, the gas supply 70 is turned off after the vacuum deposition process.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A vacuum chamber inlet device for a vacuum chamber, comprising:
a gas providing element having an inlet and a plurality of outlets;
a plurality of flow control elements connected to the outlets of the gas input element; and
a plurality of gas input elements, each of the gas input elements having an first end connected to the flow control elements and a second end disposed in the vacuum chamber, and a gas vent being formed on the second end.

2. The vacuum chamber inlet device as claimed in claim 1, wherein the flow control elements are controlling valves.

3. The vacuum chamber inlet device as claimed in claim 2, wherein each of the controlling valves has an input port and an output port.

4. The vacuum chamber inlet device as claimed in claim 3, wherein each input port is connected to a corresponding outlet of the gas input element.

5. The vacuum chamber inlet device as claimed in claim 3, wherein each output port is connected to the first end of the gas input element.

6. The vacuum chamber inlet device as claimed in claim 1, wherein the gas input elements are pipes, and have different heights in the vacuum chamber.

7. The vacuum chamber inlet device as claimed in claim 1, wherein the gas input elements are stainless steel pipes.

8. A vacuum apparatus, comprising:
a vacuum chamber;
a gas inlet device connected to the vacuum chamber, comprising:
a gas providing element having an inlet and a plurality of outlets;
a plurality of flow control elements connected to the outlets of the gas input element; and
a plurality of gas input elements, each of the gas input elements having a first end connected to the flow control elements and a second end disposed in the vacuum chamber, a gas vent being formed on the second end.

9. The vacuum apparatus as claimed in claim 8, wherein the flow control elements are controlling valves.

10. The vacuum apparatus as claimed in claim 9, wherein each of the controlling valves has an input port and an output port.

11. The vacuum apparatus as claimed in claim 10, wherein each input port is connected to a corresponding outlet of the gas input element.

12. The vacuum apparatus as claimed in claim 10, wherein each output port is connected to the first end of the gas input element.

13. The vacuum apparatus as claimed in claim 8, wherein the gas input elements are pipes, and have different heights in the vacuum chamber.

14. The vacuum apparatus as claimed in claim 8, wherein the gas input elements are stainless steel pipes.

15. A Vacuum apparatus comprising:
a vacuum chamber;
a plurality of gas providing elements, each of the gas input elements having a gas input end located outside the chamber, and a gas output end disposed inside the chamber, the gas output ends being located at differently heights in the chamber;
a gas supply element configured for supplying gas to the gas input elements and connected with the gas input elements in such a manner that communications between the gas supply element and the gas input elements are separately adjustable.
